(19) United States
(12) Patent Application Publication
(10) Pub. No.: US 2017/0145630 A1
(43) Pub. Date: May 25, 2017

(54) BIAXIALLY EXPANDED POLYMER FILM, TUFTED CARPET COMPRISING IT AND METHOD FOR THEIR MANUFACTURE

(71) Applicant: LABORA VISION B.V., Eindhoven (NL)

(72) Inventors: Lawrence Fabian Batenburg, Eindhoven (NL); Henricus Johannes Maria van Tilburg, Eindhoven (NL)

(21) Appl. No.: 15/129,665

(22) PCT Filed: Mar. 26, 2015
(86) PCT No.: PCT/NL2015/050193

§ 371 Date: Sep. 27, 2016

(30) Foreign Application Priority Data
Mar. 27, 2014 (EP) 14161929.6

(51) Int. Cl. D06N 7/00; B32B 5/02; C09J 7/00; D05C 17/02; C08J 5/18; B32B 37/12; B32B 7/12

(52) U.S. Cl. CPC D06N 7/0076; B32B 37/1207; B32B 5/02; B32B 7/12; D05C 17/02; C08J 5/18; C09J 7/00; B32B 2037/1223; B32B 2307/31; B32B 2471/02; D06N 2203/045; D06N 2203/042; D06N 2203/041; D06N 2203/061; D06N 2203/065; D06N 2203/068; C08J 2300/22; C08J 2331/04; C08J 2323/08; C09J 201/00

(57) ABSTRACT

The invention relates to a self-supporting polymer film, to a process for preparing said self-supporting polymer film, to a hot-melt adhesive, to uses of a self-supporting polymer film, to a method for preparing an assembly of at least two objects, and to a tufted carpet. The self-supporting polymer film of the invention comprises a continuous layer of a thermoplastic composition comprising a thermoplastic polymer, wherein the composition has a melt flow index (MFI) of 100 g/10 minutes or more, and wherein the polymer film is biaxially expanded.

The invention relates to a self-supporting polymer film, to a process for preparing said self-supporting polymer film, to a hot-melt adhesive, to uses of a self-supporting polymer film, to a method for preparing an assembly of at least two objects, and to a tufted carpet.

Polymer films can be used as hot-melt adhesives. Hot-melt adhesives comprise a thermoplastic component. They are applied by providing the adhesive on a substrate and activating the adhesive by heating and melting the thermoplastic component and subsequent solidification of the thermoplastic component upon cooling. This provides intimate contact between the adhesive and the substrate thereby allowing the hot-melt adhesive to act as adhesive due to its tackiness and/or flow properties in the molten state and strength after solidification. Hot-melt adhesives provide numerous advantages, such as being solvent-free, non-volatile and fast-curing. In addition, hot-melt adhesives can be low in volatile organic compounds.

An important property of hot-melt adhesives is their melt flow index (MFI). Processing and handling of hot-melt adhesives generally becomes more challenging with increasing MFI. However, for the application on the substrate, a high MFI is desirable, in particular on fibrous substrates, such as for locking tufts of tufted carpets.

Generally, a hot-melt adhesive is applied on a substrate in a way that depends on the process wherein the hot-melt adhesive is used and the properties of the hot-melt adhesive material. For example, hot-melt adhesives can be applied in molten form to a substrate material using applicator rolls that pass through a reservoir of molten adhesive. This method becomes less practical hot-melt adhesives with high MFI. The molten adhesive can also be applied on a substrate by extrusion.

Moreover, hot-melt adhesives can also be applied as a solid material on substrate and heated in contact with the substrate. This advantageously provides for easy handling and for a more controlled application method. Such hot-melt adhesives are generally applied in the form of granules or powder. Hot-melt adhesive powder is generally applied on a substrate by powder dusting. A disadvantage of hot-melt adhesive powders and granules is that they are difficult to prepare, due to the expensive cryogenic milling that is required and due to the stickiness of the powder after milling. This also limits precise, controlled application on a substrate.

Hot-melt adhesives with a low MFI can also be applied in the form of films or sheets. Polymer films are typically formed by blown film extrusion or cast film extrusion. For blown film extrusion, normally a maximum MFI of about 10 is applied and for cast film extrusion a maximum MFI of about 15. Hot-melt adhesives with a much higher MFI, such as above 50, are not available as films.

U.S. Pat. No. 6,331,355 describes polymeric films prepared by the blown film process from thermoplastic copolymer with a MFI of 18 g/10 min.

EP-A-0 101 028 discloses an extrudable self-supporting hot-melt adhesive sheet. The hot-melt adhesive sheet is not biaxially expanded.

JP-A-2001 046 778 describes an adhesive film that comprises ethylene/vinyl acetate copolymer. There is no disclosure of a biaxially expanded film with a thermoplastic composition having a melt flow index of 100 g/10 min or higher.

The tufting of carpets is a particularly demanding application of adhesive materials. The presently used adhesive materials, such as carboxylated styrene-butadiene rubber (SBR) latex have numerous disadvantages and better adhesive materials have for years been sought.

In tufted carpets, tufts of yarn are inserted in a primary backing. Primary backings are typically made of woven or non-woven fabrics. Suitable fibres for primary backings include natural or synthetic fibres or yarns, made from materials such as a polyolefin, for example polyethylene and polypropylene, and polyesters, polyamides, jute and wool. Accordingly, tufts are formed by clusters of yarn or fibre drawn through a fabric of the primary backing and projecting form the surface in the form of loops or cut yarn.

The tufts of yarn are usually held in place in the primary backing to some extent by an untwisting action of the yarn of the tufts in combination with shrinkage of the primary backing fabric. In addition, an adhesive, commonly referred to as a back coat, is normally applied to the backside of the primary backing to enhance locking or anchoring of tufts to the primary backing. Hence, an important aspect of the manufacture of a carpet is the locking of the tufts, typically by applying an adhesive material as carpet back coat.

Carboxylated styrene-butadiene rubber (SBR) latex is often used for carpet back coating in view of its low costs, ease of use and binding power. However, use of SBR and other aqueous polymer dispersions has important disadvantages. First, because of the need to evaporate water in the drying step, the energy use is very high and use of long ovens (100-200 m) is needed, involving high capital and operating costs. In addition, use of SBR latex results in the typical smell of new carpets, which is often considered unpleasant. Furthermore, the SBR latex is cross-linked on curing and hence becomes a thermoset. This makes separation of the separation of the primary and secondary backing and the tufts difficult, and forms an obstacle for recycling of carpets. In addition SBR back coatings have a large weight per area. As an alternative, the a process using a Klieverik Carpet Fusing Calander® can be used for latex-free thermobonding of non-woven heat-setting carpet fusing. However, this process has a limited scope of application and is difficult to control precisely. Dusting of hot-melt powder forms in principle another alternative; however this is not used for locking carpet tufts.

As an alternative to SBR back coatings, hot-melt adhesives have been suggested. A problem with hot-melt adhesives as back coat is to obtain effective distribution of the hot-melt adhesive material in the tufts. A good distribution is important to obtain good wear characteristics of the carpet including sufficient delamination strength and tuft bind strength.

U.S. Pat. No. 4,844,765 describes a hot-melt adhesive sheet comprising 30-40 wt. % ethylene-vinyl acetate copolymer (EVA) containing about 10 to about 35 wt. % vinyl acetate as a back-coat for anchoring tufts of yarn in a primary backing of a tufted carpet, wherein the EVA copolymer can have a MFI of 100-400. One of the disadvantages of these sheets is that the process of preparing these materials is very time consuming, difficult and generally not desired economically.

GB-A-2 284 152 discloses a method for manufacturing a tufted carpet using a polyolefin composition. The applied polyolefin composition is not in the form of a biaxially expanded sheet.

US-A-2004/0 197 522 describes preparing a tufted carpet with a polymer adhesive. The polymer adhesive described in this document is not in the form of a self-supporting film.

WO-A-98/38375 discloses a method for preparing a carpet, wherein the carpet may have an extruded sheet of a thermoplastic material as an additional backing. The extruded sheet is, however, not in the form of a self-supporting film.

For these reasons, a need exists for a thermoplastic material having improved adhesive properties. Objective of the invention is to provide such a thermoplastic material and to address at least in part the described disadvantages of hot-melt adhesives in the prior art.

The inventors found that this objective can be met by a thermoplastic material having a specific form and specific melt properties.

Accordingly, in a first object, the invention relates to a self-supporting polymer film comprising a continuous layer of a composition comprising a thermoplastic polymer, said composition having a melt flow index (MFI) of 100 g/10 minutes or more, wherein said polymer film is biaxially expanded.

The polymer film can advantageously provide a strong lock of the tufted fibres of carpets (tuft-lock) and increased the “pull-out-strength” of tufted fibres.

The polymer film of the invention was found to be highly advantageous as hot-melt adhesive, in particular for affixing yarn and/or fibres together and/or to a substrate, such as in tufted carpets. Without wishing to be bound by way of any theory, it is believed that the adhesive strength of hot-melt adhesives is provided at least in part by the molten thermoplastic composition entering irregularities in the surface of the substrate, such as into tufts. This can result in interlocking with these irregularities after solidification of the thermoplastic composition and thereby provide for example a good tuft lock. In particular for hot-melt adhesives applied on fibrous materials such as textiles, this is believed to be an important mechanism. In addition, a large surface area of the interface between the yarn and/or fibres and the thermoplastic composition contributes to adhesive strength and can be obtained with a thermoplastic composition with a high MFI by virtue of wetting of the fibres and/or yarn by capillary forces of fibres and in fibre bundles, for example as in tufted carpets. A high MFI of the hot melt adhesive (such as above 100 g/10 minutes) is even more important in case many individual fibres have to be affixed to a substrate, such as for example by carpet back-coatings.

The term “activation temperature” of a hot-melt adhesive as used in this application is meant to refer to the temperature which the adhesive must reach to achieve an acceptable bond with a substrate.

The polymer film preferably has a thickness of 2 mm or less, more preferably a thickness of 0.25 mm or less, typically more than 1 μm, and therefore may include somewhat thicker films or sheets having a thickness of 0.25-2 mm or even larger thickness. The polymer film comprises may comprise thermoplastic and thermoset components. The film is preferably a continuous film having a width of 10 cm or more. Preferably, the film has a width of 50 cm or more, such as 1 m or more, 2 m or more, for example 5 m or less. Polymer films with such widths can be obtained using blown film extrusion and/or cast film extrusion. Preferably, the polymer film is a blown film.

The film is preferably flexible and can be rolled and is self-supporting. The polymer film can be a monolayer or multilayer film.

The polymer film comprises a continuous layer of a thermoplastic composition comprising a thermoplastic polymer. The continuous layer preferably consists of the thermoplastic composition. The layer preferably has a thickness of 500 μm or less, typically 200 μm or less, more preferably 100 μm or less, typically more than 1 μm. The polymer film preferably is a monolayer film consisting of such a layer and having these thicknesses.

Suitable thermoplastic polymers include ethylene-vinyl acetate (EVA) co-polymers, ethylene-acrylate polymer, ethylene methacrylate (EMA), polyolefins such as polyethylene including low density polyethylene (LDPE) and high density polyethylene (HDPE), polypropylene, polybutene-1, polyamides, polyesters, polyurethanes. The thermoplastic composition can comprise polymer blends of one or more, such as two or three, types of thermoplastic polymer materials, to adjust melt properties and viscosities. For example, suitable blends include EVA/LDPE, EVA(400)/EVA(10) and EVA/EMA.

The thermoplastic composition can further optionally comprise waxes, e.g. microcrystalline waxes, to reduce melt viscosity and to obtain a higher MFI.

Other optional components of the thermoplastic composition include usual additives for hot-melt adhesives, such as fillers, e.g. calcium carbonate, talc, silica, clays, antioxidants (e.g. hindered phenols, butylated hydroxytoluene, phosphites, phosphates, and hindered aromatic amines), stabilisers, antifoaming agents, plasticisers, pigments, biocides, flame retardants and lubricants.

In some embodiments, the polymer film comprises 10-100 wt. % of thermoplastic polymer.

The thermoplastic composition preferably comprises one or more infrared (IR) absorption agents, for example carbon blacks and metal oxides, pigments and/or dyes. An infrared absorption agent preferably absorbs electromagnetic radiation with a wavelength of 700 nm to 1 mm (infrared), preferably 700-1400 nm; preferably the infrared absorption agent has a broad absorption band and/or an absorption maximum in these ranges. Suitable infrared absorption agents include for example carbon black, silica, cristabolite, kaolin, talc, metals, metal oxides, silicates and aluminium silicates. Including these compounds in polymer films allows for quicker melting if needed, such as to activate a hot-melt adhesive.

The thermoplastic composition has a melt flow index (MFI) of 100 g/10 minutes or more, preferably 200 g/10 minutes or more, such as 300-500 g/10 minutes, for example about 400 g/10 minutes. It is even possible that the thermoplastic composition has a melt flow index (MFI) of 400 g/10 minutes or more, such as 400-500 g/10 minutes. Hot-melt thermoplastic compositions with such a high MFI allow for good adhesion on fibrous materials. The MFI is conventionally used in the field of thermoplastic materials to indicate relative melt viscosities.

The melt flow index can be measured according to ASTM D1238, typically using a 2.16 kg weight and a temperature of 190° C. The melt flow index is as measured for the total thermoplastic composition, including any fillers and blends that may optionally be present.

Accordingly, the polymer film comprises a layer having such MFI and/or melt viscosity. In addition, preferably the thermoplastic polymer has such a MFI.

Although one or more components of the thermoplastic composition may have a MFI and/or melt viscosity outside these ranges, it is important that the total thermoplastic composition has a MFI and/or melt viscosity as described herein in order to obtain good contact between the hot melt adhesive and the substrate.

Preferably, the thermoplastic composition has a softening point of 60° C. or lower, more preferably 50° C. or lower. Preferably, the thermoplastic composition has a melting point of 60-130° C., more preferably 50-110° C.

The polymer film of the invention is biaxially expanded. A “biaxially expanded film” as used in this application is meant to refer to a film that has been stretched in two different directions. The biaxial stretching of a polymer film in two different directions may result in a net symmetrical or asymmetrical stretch in the two chosen axes. The biaxial expansion of the polymer film is a typical result of a blow film extrusion production process, thereby yielding a film that is structurally distinguished from films that are otherwise prepared. The resulting polymer films are self-supporting and not at all not sticky, thereby making them very easy to handle, in particular for applications where the polymer film is used for anchoring tufted yarn to primary backings of carpets.

In an aspect, the invention relates to a process for preparing a polymer film, preferably as described herein, comprising blown film extrusion of a tubular film from a melt of at least a thermoplastic composition as described herein. The process typically further includes flattening said tubular film into a flat film, such as by collapsing and cutting.

The process preferably comprises plasticising the components in an extruder, such as using a three-zone screw. A tubular film can then be formed from the melt using a blown film moulding tool. Accordingly, a resin of the adhesion composition is first melted by applying heat and/or pressure in an extruder and the melt is forced through an annular die into a tubular film. Pressurised air is injected through a hole in the centre of the die, and the pressure causes the extruded melt thereby stretching, expanding and thinning the tubular film. The resulting tubular thin film is often referred to as “bubble” and is continually pulled outwards from the die and cooled. Accordingly, the tubular film is biaxially expanded. Cooling of the tubular film can be carried out using a cooling ring around the bubble, blowing air on the tubular film and also from the inside of the bubble using the air injected in the bubble. Due to this cooling, the thermoplastic material of the film solidifies. The tubular film is after expansion and cooling formed into flat film layers, typically by collapsing using nip rolls and cutting. The flat films are then most often rolled up onto windup rollers.

Between the nip rollers and the windup rollers, the film may pass through a treatment centre, depending on the application. During this stage, the film may be slit to form one or two films and/or be surface treated. Typical surface treatments comprise including corona, flame and/or fluorine treatment.

During blown film extrusion, the diameter of the bubble is inflated and the film is expanded and pulled outward and away from the annular die. Therefore, in order to obtain a stable bubble, the melt of the thermoplastic composition should have sufficient melt strength to produce a film. The blown film extrusion is preferably carried out at a temperature of 50-100° C., more preferably 70-90° C., or 60-80° C., or 60-78° C.

Multilayer films can be made using blown film extrusion by co-extrusion. In such a process, two or more materials are simultaneously extruded through a single die. The orifices in the die are arranged such that the layers merge before cooling.

The invention also relates to a polymer film obtainable using such blown film extrusion process, preferably having the properties and composition as described herein. The polymer films of the invention can be used in hot-melt adhesives, for example for tuft-locking.

In a further aspect, the invention relates to a hot-melt adhesive comprising the self-supporting polymer film. Preferably, the hot-melt adhesive has the form of a film or sheet, for example a monolayer film or a multi-layer film, comprising or consisting of the polymer film. The hot-melt adhesive exposes on at least one surface the thermoplastic composition. In case of a hot-melt adhesive film, preferably one or both sides of the hot-melt adhesive film are formed at least partly by an exposed surface of a layer consisting of the thermoplastic composition. Accordingly, when in the hot-melt adhesive is in contact with a substrate surface at a temperature above the activation temperature, the exposed thermoplastic composition can conform to the surface of the substrate.

Compared to hot-melt adhesives applied as powder or granules, the adhesive film provides uniform thickness, complete coverage without voids or gaps and a cohesive strength that does not depend on fusion of the powder particles or granules. This allows for faster application of the hot-melt adhesive and for example for directly locking the tufted yarns/fibres. The high MFI of the thermoplastic composition can contribute to good and fast wetting of the substrate resulting in increased adhesive strength.

The hot-melt adhesive is preferably a pre-applied and/or preformed thermoplastic adhesive. An example of a preformed adhesive would be a film. An example of a pre-applied adhesive is one that is coated onto one substrate and allowed to cool. In a subsequent operation the adhesive is reheated to the recommended activation temperature and, with heat and pressure, bonds to a second substrate.

Accordingly, preferably said hot-melt adhesive is a multilayer film having two exposed outer layers, wherein one or both of said exposed outer layers comprise said thermoplastic composition. Such a hot-melt adhesive multilayer film exposes the thermoplastic composition on at least part of its external surface allowing for interfacing the thermoplastic composition with a substrate surface.

Advantages of multilayer hot-melt adhesives include that the polymer film can be thinner, for example have a thickness of 25 μm or less, allowing for a reduced amount of thermoplastic composition. Another advantage is that during storage and handling of a multilayer hot-melt adhesive, stacking of the adhesive results in sandwiching of the layers comprising the thermoplastic composition, thereby reducing stickiness.

In a further aspect, the invention relates to a method for preparing an assembly of at least two objects, said process comprising contacting a hot-melt adhesive as described herein comprising said polymer film to at least a first object and a second object, increasing the temperature of the hot-melt adhesive to above the activation temperature of the hot-melt adhesive (TA) and, in contact with at least said first and second object, decreasing the temperature of the hot-melt adhesive to below the activation temperature.

Preferably, the method comprises cooling the hot-melt adhesive to ambient temperature in contact with said first and second object. Preferably, the method comprises maintaining the temperature of the hot-melt adhesive above the activation temperature T_{A} for a dwell time of at least 0.1 second and up to 10 minutes, preferably 1-10 seconds.

Preferably, the temperature of the hot-melt adhesive is increased to 50° C. or more, such as 80° C. or more or 100° C. or more, typically to a temperature less than 150° C. The hot-melt adhesive is optionally pre-applied on the first object. Preferably, the hot-melt adhesive is contacted with a surface of the first and/or second object comprising a fibrous material, such as textile. Preferably, the temperature of the hot-melt adhesive is increased by infrared radiation.

In particular, the parts of the hot-melt adhesive comprising the thermoplastic composition in contact with the objects to be attached have to reach a temperature above the activation temperature. Therefore, in case of a hot-melt adhesive film, in principle only the outer layers contacting the first and/or second object have to reach a temperature above the activation temperature.

In an embodiment, the hot-melt adhesive is contacted with a first object while having a temperature below the activation temperature, heated to a temperature above the activation temperature and thereby melted, and contacted with a second object while molten and thereafter solidified in contact with the first and second object by cooling to a temperature below the activation temperature.

The hot-melt adhesive can also be contacted with a first and second object while the hot-melt adhesive has temperature below the activation temperature and at least one of the first and second object is pre-heated to a temperature above the activation temperature, thereby heating the hot-melt adhesive to a temperature higher than the activation temperature, followed by cooling of first and/or second object and solidification of the hot-melt adhesive in contact with both.

Preferably, the method comprises pre-heating said first and/or second object prior to applying said hot-melt adhesive, preferably said first and/or second object are heated to a temperature above the temperature of the hot melt-adhesive when it is applied, more preferably to above the activation temperature, for example to 5-30° C. above the activation temperature.

In a yet further aspect, the invention relates to use of the polymer film as hot-melt adhesive, preferably as part of a back-coat of a tufted carpet. It was surprisingly found that the high MFI of the thermoplastic compositions allows the polymer film to be used as an alternative for the latex based back-coats of tufted carpets. The method of attaching objects together can be used in the manufacture of carpets.

Accordingly, in a yet further aspect, the invention relates to a process for manufacturing a tufted carpet, comprising anchoring yarn and/or fibres to a primary backing of the carpet by such a method, and/or using a hot-melt adhesive comprising the polymer film for locking the tufted yarn and/or fibres in a primary backing of the carpet. The use of a self-supporting biaxially expanded polymer film (typically obtained by a film blowing extrusion process) for anchoring yarn and/or fibres to a primary backing of a carpet greatly simplifies the conventional carpet production process. Prior art films obtained by other extrusion processes have the disadvantage of being undesirably sticky and/or requiring an additional support, thereby rendering the tufterd carpet production process more complex.

In the process, the primary backing can be the first object and the yarn or fibres the at least second object. The hot-melt adhesive can also be used for other types of carpets, such as to attach a secondary backing to a primary backing. The invention also relates to a tufted carpeted obtainable using this process.

Use of the hot-melt adhesive provides as advantage an increase of the resistance of the tufts to pull-out and enhancement of the bonding of the primary backing fabric to the tufts and/or to the secondary backing. One aspect of the resistance of the tufts to pull-out is fibre lock, which is the binding of individual fibres within a carpet tuft. Fibre lock is obtained by penetration of the thermoplastic composition of the hot-melt adhesive into the tufts, in particular by virtue of the high MFI and/or low melt viscosity. Another aspect is tuft lock, which is the amount of force required to pull an individual tuft out of the carpet. The hot-melt adhesives of the invention were found to provide excellent resistance of the tufts to pull-out. In this way, the hot-melt adhesives provide an alternative to latex-based carpet back-coats, with the additional advantage that the application of the adhesive is fast, that no long drying ovens are required and that the tufts and carpets can be separated from each other for recycling.

Preferably, the tufted carpet comprises a primary backing stitched with loops of yarn to form a tufted structure projecting outwardly from said primary backing; a hot-melt adhesive layer according to the invention attached to the primary backing; and a secondary backing affixed to the hot-melt adhesive layer. The secondary backing can comprise a woven polyolefin. The primary backing can comprise a woven or non-woven polyolefin. The yarn can comprise a polyamide.

The polymer film of the invention is especially advantageous for automotive carpets and more generally for carpets with backing having a set three-dimensional or non-planar contoured shape, for example carpets with backings having a fixed curved shape. These carpets are typically used in vehicles to cover floor areas. Automotive carpets form a demanding application, because of the requirement that the backing of the carpet conforms to the three-dimensional shape of the vehicle floor. Manufacturing such carpets typically comprises moulding the carpet to fit the interior of a specific vehicle model or even custom moulding to fit a specific, individual vehicle. The latter is often used for replacement carpets. The preferred automotive carpet comprising the polymer film of the invention can be moulded into a non-planar three dimensional contoured configuration, which typically conforms to the contours of the automobile floor so as to fit properly, for example, over the transmission hump on the floor of the automobile. Use of the polymer film of the invention as hot-melt adhesive in the manufacturing of such preferred carpet advantageously provides good tuft-lock, even with a demanding and complex curved shape of the backing. In addition, good tuft-lock is highly desired by consumers in particular for tufts at the edges of the carpet. Moreover, low manufacturing costs are very important, in particular for customised and/or replacement carpets. Manufacturing methods used for conventional floor matting are considered unsuitable for automotive carpets because, among other things, the tendency of such carpeting for floors to become detached from the backing material during normal use, especially at the peripheral edges. This is even more important because of the relatively small surface area of automotive carpets compared to broadloom carpets). Sometimes overlay mats or lining carpets for vehicles are beaded to mitigate this problem; however such beadings are costly to produce. The hot-melt adhesive comprising the polymer film of the invention forms an attractive solution to this problem of detaching at the edges.

Another preferred use of the hot-melt adhesive of the invention is in the manufacturing of artificial turf, also known as synthetic turf or artificial grass. Synthetic turf typically differs in composition from carpet, in that the majority of carpet products use nylon face fibres as tufts, while the majority of current synthetic turf products use polyethylene. The primary coating of most broadloom carpet is a latex coating, while the primary coating in most synthetic turf is polyurethane. There is a belief that polyurethane coated synthetic turf as a whole cannot be recycled as polyurethane is thermoset and is therefore difficult and costly to recycle. In contrast, the preferred artificial turf, for example comprising polyolefin tufts, more in particular polyethylene tufts, comprising hot-melt adhesive of the invention is suitable for recycling as described hereinabove.

All references cited herein are hereby completely incorporated by reference to the same extent as if each reference were individually and specifically indicated to be incorporated by reference and were set forth in its entirety herein.

The use of the terms “a” and “an” and “the” and similar referents in the context of describing the invention (especially in the context of the claims) are to be construed to cover both the singular and the plural, unless otherwise indicated herein or clearly contradicted by context. The terms “comprising”, “having”, “including” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. For the purpose of the description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include and intermediate ranges therein, which may or may not be specifically enumerated herein.

Preferred embodiments of this invention are described herein. Variation of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject-matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

For the purpose of clarity and a concise description features are described herein as part of the same or separate embodiments, however, it will be appreciated that the scope of the invention may include embodiments having combinations of all or some of the features described.

1. A self-supporting polymer film comprising a continuous layer of a thermoplastic composition comprising a thermoplastic polymer, said thermoplastic composition having a melt flow index (MFI) of 100 g/10 minutes or more, wherein said polymer film is biaxially expanded.

2. A self-supporting polymer film according to claim 1, wherein said thermoplastic composition has a MFI of 300-500 g/10 minutes.

3. A self-supporting polymer film according to claim 1 or 2, wherein said thermoplastic composition has a MFI of 400-500 g/10 minutes.

4. A self-supporting polymer film according to any one of claims 1-3, wherein said layer has a thickness of 500 μm or less.

5. A self-supporting polymer film according to any one of claims 1-4, wherein said layer has a thickness of 100 μm or less.

6. A self-supporting polymer film according to any one of claims 1-5, wherein said composition comprises an infrared absorption agent.

7. A self-supporting polymer film according to any one of claims 1-6, wherein said thermoplastic polymer comprises one or more selected from the group consisting of ethylene-vinyl acetate co-polymers, ethylene-acrylate polymer, polyolefins, polyamides, polyesters and polyurethanes.

8. A self-supporting polymer film according to any one of claims 1-7, wherein said thermoplastic polymer comprises at least two different polymer selected from the group consisting of ethylene-vinyl acetate co-polymers, ethylene-acrylate polymer, polyolefins, polyamides, polyesters and polyurethanes.

9. A self-supporting polymer film according to any one of claims 1-8, wherein said thermoplastic polymer comprises ethylene-vinyl acetate co-polymer.

10. A self-supporting polymer film according to any one of claims 1-9, wherein said thermoplastic composition further comprises one or more waxes.

11. Process for preparing a self-supporting polymer film according to any one of claims 1-10, comprising blow film extruding a tubular film from a melt of at least said thermoplastic composition.

12. Process according to claim 11, wherein the film is blown at a temperature of 50-100° C.

13. Process according to claim 11 or 12, wherein the film is blown at a temperature of 60-78° C.

14. Process according to any one of claims 11-13, wherein said self-supporting polymer film is a multilayer film, and wherein said process comprises simultaneous extruding of two or more materials through a single die.

15. A hot-melt adhesive comprising a self-supporting polymer film according to any one of claims 1-10.

16. A hot-melt adhesive according to claim 15, wherein said hot-melt adhesive is a multilayer film having two exposed outer layers, wherein one or both of said exposed outer layers comprises said thermoplastic composition.

17. Use of a polymer film according to any one of claims 1-10 as hot-melt adhesive.

18. Use according to claim 17, wherein the hot-melt adhesive is applied as part of a back-coat of a tufted carpet.

19. Use according to claim 17 or 18, wherein the hot-melt adhesive is applied in the manufacturing of artificial turf.

20. A method for preparing an assembly of at least two objects, said process comprising contacting a hot-melt adhesive according to claim 15 or 16 to at least a first object and a second object, increasing the temperature of the hot-melt adhesive to above the activation temperature of the hot-melt adhesive (TA) and, in contact with at least said first and second object, decreasing the temperature of the hot-melt adhesive to below the activation temperature.

21. Method according to claim 20, comprising pre-heating said first and/or second object prior to applying said hot-melt adhesive.

22. Method according to claim 20 or 21, wherein said first object and/or said second object comprise a fibrous material, such as textile.

23. Process for manufacturing a tufted carpet, comprising anchoring tufted yarn and/or fibres to a primary backing of the carpet by a method according to claim any one of claims 20-22.

24. Process according to claim 23, comprising using a hot-melt adhesive according to claim 15 or 16 for locking the tufted yarn and/or fibres in a primary backing of the carpet.

25. Tufted carpet comprising a primary backing stitched with loops of yarn to form a tufted structure projecting outwardly from said primary backing; a layer of hot-melt adhesive according to claim 15 or 16, attached to the primary backing; and a secondary backing affixed to the hot-melt adhesive layer.
